(19) United States
(12) Patent Application Publication
(10) Pub. No.: US 2006/0223476 A1
(43) Pub. Date: Oct. 5, 2006

(54) Antenna selection diversity apparatus and method in a broadband wireless communication system

(75) Inventors: Seong-Wook Song, Gwacheon-si (KR); Young-Mo Gu, Suwon-si (KR); Yong-Chul Song, Seoul (KR); Min-Goo Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/392,899

(22) Filed: Mar. 30, 2006

(30) Foreign Application Priority Data
Mar. 30, 2005 (KR) 2005-26831

(51) Int. Cl. H04B 1/06; H04B 7/00

(52) U.S. Cl. 455/277.2

(57) ABSTRACT

An apparatus and method for improving antenna diversity in a receiver of a broadband wireless communication system using multiple antennas are provided. The receiver with the diversity apparatus uses a structure of multiple analog front ends, a structure for measuring antenna-by-antenna reception power values/Carrier-to-Interference plus Noise Ratios (CINRs) after Fast Fourier Transform (FFT) using a single analog front end, and a structure based on a single analog front end for measuring antenna-by-antenna reception power values after Analog-to-Digital (A/D) conversion without use of FFT. When a receive antenna is selected, the measured reception power values/CINRs are used. In a system for transmitting pilot signals with preamble data in a regular pattern, the receiver can have improved performance through a suitable frequency modulation process and can be implemented at low cost, as compared with that of the conventional antenna selection diversity.

### CROSS-REFERENCE TO RELATED APPLICATIONS

This application claims the benefit under 35 U.S.C. § 119(a) to Korean Patent Application No. 2005-26831, filed Mar. 30, 2005, in the Korean Intellectual Property Office, the entire contents of which are hereby incorporated by reference.

### BACKGROUND OF THE INVENTION

1. Field of the Invention

The present invention generally relates to a diversity apparatus and method in a broadband wireless communication system. More particularly, the present invention relates to a diversity apparatus and method that can improve antenna diversity in a receiver of a broadband wireless communication system using multiple antennas.

2. Description of the Related Art

A typical example of a wireless communication system is a mobile communication system. Mobile communication systems have been developed for voice communication. According to the demands of users and the rapid progress of technology, the mobile communication system has reached the step of providing not only conventional voice service but also a broadband data service capable of transmitting a large amount of digital data such as e-mail and still or moving images. A typical broadband wireless communication system for providing broadband data service is an Orthogonal Frequency Division Multiplexing (OFDM) system.

A transmission scheme using the OFDM system converts a serially input symbol stream in parallel and then modulates and transmits a conversion result through a plurality of orthogonal subcarriers. With the development of Very Large Scale Integration (VLSI) technology in the 1990s, the OFDM transmission scheme began to be of greater interest. Generally, the OFDM transmission scheme modulates data using the plurality of subcarriers, maintains mutual orthogonality between the subcarriers, and has the characteristic of robustness to a frequency-selective multipath-fading channel as compared with a conventional single carrier modulation scheme.

The OFDM transmission scheme transmits a Cyclic Prefix (CP) added to the head end of each OFDM symbol, thereby removing InterSymbol Interference (ISI) from a previous symbol and interchannel interference. Due to the characteristic of robustness to interference, the OFDM transmission scheme is suitable for broadband high-speed communication. Thus, the OFDM transmission scheme is receiving attention as a transmission technique capable of guaranteeing high reception quality and high-speed transmission and reception in a broadband service such as the wireless Internet, or the like.

An Orthogonal Frequency Division Multiple Access (OFDMA) scheme has been proposed as a typical multiple-access scheme based on OFDM. The OFDMA scheme divides and loads an OFDM symbol on a plurality of subcarriers, and combines and transmits the plurality of subcarriers into one subchannel. An example of applying the OFDMA scheme to the broadband wireless communication system is an Institute of Electrical and Electronics Engineers (IEEE) 802.16a, 802.16e or WiBro system. Hereinafter, a broadband wireless communication system is interpreted as meaning a wireless communication system using IEEE 802.16a, 802.16e, WiBro, OFDM, and/or OFDMA systems.

To accommodate a request for more increased high-speed data transmission, various communication techniques using multiple antennas in a base station and a terminal have been proposed. As an example of using multiple antennas, a coherent combining method for performing maximum ratio combining of a Code Division Multiple Access (CDMA) system maximizes a signal-to-noise ratio by varying a phase, and assigning a weight, for each antenna's received signal using channel information of each antenna. This method is excellent in terms of improving reception performance, but it increases the complexity of a receiver because additional processes such as channel information measurement and weight computation are required in the receiver.

There is also an antenna selection diversity method for selecting an antenna in the receiver as another example of using multiple antennas. This method selects an antenna with the largest received signal power from among the multiple antennas provided in the receiver and performs a signal process such as modulation through the selected antenna. Because this method receives a signal using only the selected antenna after the antenna selection, its receiver implementation is simple as compared with that of the coherent combining method for combining outputs of the multiple antennas.

FIG. 1 illustrates a structure of a broadband wireless communication system to which a conventional antenna selection diversity technique is applied in a receiver. In FIG. 1, a transmitter 100a and a receiver 100b may be either a base station or a terminal. Hereinafter, for convenience of explanation, it is assumed that the transmitter 100a and the receiver 100b correspond to the base station and the terminal, respectively, and an applied wireless communication system is an OFDM system.

First, information bits to be transmitted from the transmitter 100a of the base station to a terminal are encoded through an encoder (not illustrated) for error correction and the encoded information bits are input to a modulator 101. The modulator 101 modulates the encoded information bits in a predefined modulation scheme such as Quadrature Phase Shift Keying (QPSK), 16-Quadrature Amplitude Modulation (16 QAM), 64-Quadrature Amplitude Modulation (64 QAM), or the like, and the modulated information bits are output to a symbol mapper 103. The symbol mapper 103 arranges input data according to a frequency-axis subcarrier index and a time-axis OFDM symbol index, maps the input data to subcarriers of the OFDM symbol, and outputs the mapped input data to an Inverse Fast Fourier Transform (IFFT) processor 105.

Although not illustrated in FIG. 1, serial modulation symbols are converted to parallel modulation symbols before they are output to the IFFT processor 105, and a pilot symbol is inserted. The IFFT processor 105 performs an N-point IFFT operation on the parallel modulation symbols. A Cyclic Prefix (CP) inserter 107 inserts a CP into every predefined guard interval to prevent intersymbol and/or interchannel interference, and outputs an insertion result to a Digital-to-Analog Converter (DAC) 109. A Radio Frequency (RF) module 111 performs an RF process for a symbol stream converted to an analog signal from the DAC 109, and transmits the RF signal to a wireless network through an antenna 113.

The receiver 100b of the terminal receives an OFDM symbol stream transmitted from the base station through one antenna selected between first and second antennas 115 and 117. In FIG. 1, it is assumed that the OFDM symbol stream is received through the first antenna 115. After an RF module 121 performs an RF process for the received OFDM symbol stream, an output of the RF module 121 is multiplied by a sinusoidal signal cos(2πf_{c}t) in a multiplier 123, and is demodulated to f_{c}. Herein, f_{c} refers to the center frequency of a subcarrier. An Analog-to-Digital Converter (ADC) 125 converts a demodulated OFDM symbol stream to a digital signal and then outputs the digital signal to a CP remover 127. The CP remover 127 removes a CP inserted into a guard interval. The OFDM symbol stream from which the CP has been removed is converted to a parallel signal. The parallel OFDM symbol stream is input to a Fast Fourier Transform (FFT) processor 129.

The FFT processor 129 converts the parallel OFDM symbol stream to a frequency domain signal. A demodulator 131 demodulates the frequency domain signal according to a modulation scheme such as QPSK, 16 QAM, 64 QAM, or the like, and then outputs encoded information bits. The encoded information bits are recovered to an original signal. On the other hand, an output of the ADC 125 of FIG. 1 is transferred to a power calculator 133. The power calculator 133 switches the first and second antennas 115 and 117 within a preamble interval as illustrated in FIG. 2.

FIG. 2 illustrates an antenna switching time in a receiver to which the conventional antenna selection diversity technique is applied. Referring to FIG. 2, reception power computation 23 for the first antenna (ANT1) 115 is performed in Switching Time 0 within the preamble interval 21, and reception power computation 25 for the second antenna (ANT2) 117 is performed in Switching Time 1 within the preamble interval 21. Reception power values of the antennas (ANT1 and ANT2) are transferred to an antenna selector 135. The antenna selector 135 controls a switch 119 such that an antenna with a relatively large reception power value is selected as a receive antenna among these antennas.

Generally, a preamble in the OFDM and/or OFDMA systems is widely used for synchronization and channel estimation such as time-offset estimation, carrier frequency estimation, and so on. However, the conventional antenna selection diversity technique has a problem in that a terminal cannot use preamble data while a switching operation of the switch 119 is performed because the preamble interval 21 of FIG. 2 is divided as reception power values of the antennas 115 and 117 are measured.

Accordingly, there is a need for an improved antenna selection method and a broadband wireless communication system using the same.

### SUMMARY OF THE INVENTION

Exemplary embodiments of the present invention address at least the above problems and/or disadvantages and provide at least the advantages described below. It is, therefore, an exemplary object of the present invention to provide a reception apparatus and method for performing antenna selection diversity while employing preamble data in a broadband wireless communication system.

It is another exemplary object of the present invention to provide an antenna selection diversity reception apparatus and method applied to a receiver using multiple analog front ends in a broadband wireless communication system.

It is yet another exemplary object of the present invention to provide an antenna selection diversity reception apparatus and method applied to a receiver using a single analog front end in a broadband wireless communication system.

In accordance with an exemplary aspect of the present invention, there is provided a reception apparatus for performing antenna selection diversity in a broadband wireless communication system, comprising: a plurality of antennas for receiving pilot signals transmitted in a regular period; a plurality of analog front ends for converting the pilot signals received through the plurality of antennas to digital signals; a power calculator for computing antenna-by-antenna reception power values from output signals of the plurality of analog front ends; and an antenna selector for selecting an antenna with a largest reception power value as a receive antenna among the plurality of antennas.

In accordance with another exemplary aspect of the present invention, there is provided a reception apparatus for performing antenna selection diversity in a broadband wireless communication system, comprising: a plurality of antennas for receiving pilot signals transmitted in a regular period; a plurality of demodulators for demodulating antenna-by-antenna received signals to different frequencies according to a distance between subcarriers through which the pilot signals are transmitted; a Fast Fourier Transform (FFT) processor for performing an FFT process for the antenna-by-antenna received signals; a power calculator for measuring antenna-by-antenna reception power values from an output signal of the FFT processor; and an antenna selector for selecting an antenna with a largest reception power value as a receive antenna among the plurality of antennas.

In accordance with another exemplary aspect of the present invention, there is provided a reception apparatus for performing antenna selection diversity in a broadband wireless communication system, comprising: a plurality of antennas for receiving pilot signals transmitted in a regular period; a plurality of demodulators for demodulating antenna-by-antenna received signals to different frequencies according to a distance between subcarriers through which the pilot signals are transmitted; a single analog front end for converting the antenna-by-antenna received signals to digital signals; a power calculator for measuring antenna-by-antenna reception power values from an output signal of the single analog front end; and an antenna selector for selecting an antenna with a largest reception power value as a receive antenna among the plurality of antennas.

In accordance with another exemplary aspect of the present invention, there is provided an antenna selection diversity method of a receiver in a broadband wireless communication system, comprising the steps of: receiving pilot signals transmitted in a regular period through a plurality of antennas; converting the pilot signals received through the plurality of antennas to digital signals; measuring antenna-by-antenna reception power values from antenna-by-antenna output signals converted to the digital signals; and selecting an antenna with a largest reception power value as a receive antenna among the plurality of antennas.

In accordance with another exemplary aspect of the present invention, there is provided an antenna selection diversity method of a receiver in a broadband wireless communication system, comprising the steps of: receiving pilot signals transmitted in a regular period through a plurality of antennas; demodulating antenna-by-antenna received signals to different frequencies according to a distance between subcarriers through which the pilot signals are transmitted; performing a Fast Fourier Transform (FFT) process for the antenna-by-antenna demodulated received signals; measuring antenna-by-antenna reception power values from the received signals converted in the FFT process; and selecting an antenna with a largest reception power value as a receive antenna among the plurality of antennas.

In accordance with yet another exemplary aspect of the present invention, there is provided an antenna selection diversity method of a receiver in a broadband wireless communication system, comprising the steps of: receiving pilot signals transmitted in a regular period through a plurality of antennas; demodulating antenna-by-antenna received signals to different frequencies according to a distance between subcarriers through which the pilot signals are transmitted; converting the pilots signals, received by the plurality of antennas, to digital signals through a single analog front end; measuring antenna-by-antenna reception power values from an output signal of the single analog front end; and selecting an antenna with a largest reception power value as a receive antenna among the plurality of antennas.

### BRIEF DESCRIPTION OF THE DRAWINGS

The above and other objects and aspects of the present invention will be more clearly understood from the following detailed description taken in conjunction with the accompanying drawings, in which:

FIG. 1 illustrates a structure of a conventional broadband wireless communication system to which a conventional antenna selection diversity technique is applied in a receiver;

FIG. 2 illustrates a conventional antenna switching time in a receiver to which the conventional antenna selection diversity technique is applied;

FIG. 3 illustrates an antenna switching time in a receiver to which an antenna selection diversity technique in accordance with exemplary embodiments of the present invention is applied;

FIG. 4 illustrates a preamble pilot pattern to which an antenna selection diversity method in accordance with an exemplary aspect of the present invention is applied;

FIG. 5 illustrates a preamble pilot pattern to which an antenna selection diversity method in accordance with another exemplary aspect of the present invention is applied;

FIG. 6 is a block diagram illustrating a structure of a receiver with an antenna selection diversity apparatus in accordance with a first exemplary embodiment of the present invention;

FIG. 7 is a flowchart illustrating an antenna selection diversity process in accordance with the first exemplary embodiment of the present invention;

FIG. 8 is a block diagram illustrating a structure of a receiver with an antenna selection diversity apparatus in accordance with a second exemplary embodiment of the present invention;

FIG. 9 is a flowchart illustrating an antenna selection diversity process in accordance with the second exemplary embodiment of the present invention;

FIG. 10 is a block diagram illustrating a structure of a receiver with an antenna selection diversity apparatus in accordance with a third exemplary embodiment of the present invention;

FIG. 11 is a flowchart illustrating an antenna selection diversity process in accordance with the third exemplary embodiment of the present invention;

FIG. 12 is a waveform illustrating an example of a filter coefficient for estimating power of even subcarriers in accordance with an exemplary embodiment of the present invention; and

FIG. 13 is a waveform illustrating an example of a filter coefficient for estimating power of a preamble based on Institute of Electrical and Electronics Engineers (IEEE) 802.16e in accordance with an exemplary embodiment of the present invention.

Throughout the drawings, the same drawing reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will be described in detail herein below with reference to the accompanying drawings. In the following description, detailed descriptions of functions and configurations incorporated herein that are well known to those skilled in the art are omitted for clarity and conciseness.

Before a description of the exemplary embodiments of the present invention, a basic concept of the present invention will be described with reference to FIGS. 3 to 5. Hereinafter, for convenience of explanation, it is assumed that the number of antennas is two. The total number of antennas can be set to three or more.

FIG. 3 illustrates an antenna switching time in a receiver to which an antenna selection diversity technique in accordance with an exemplary embodiment of the present invention is applied. Referring to FIG. 3, reception power computation 33 for a first antenna (ANT1) and reception power computation 35 for a second antenna (ANT2) are simultaneously performed in the same Switching Time 1 of a preamble interval 31. Therefore, the present invention can compute reception power values for the respective antennas within the same preamble interval regardless of antenna switching, and can receive preamble data mapped to a selected antenna.

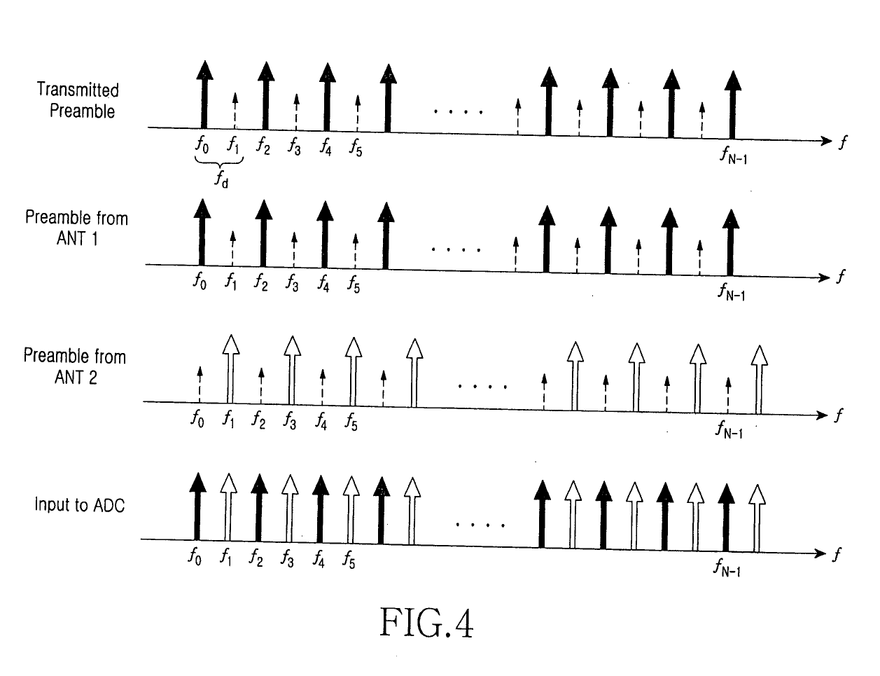

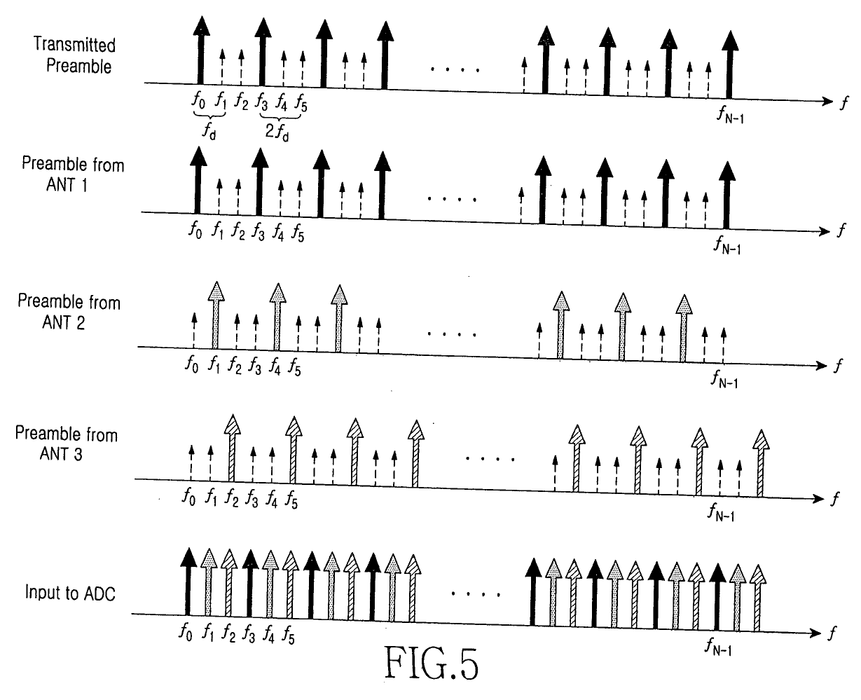

FIG. 4 illustrates a preamble pilot pattern to which an antenna selection diversity method in accordance with an exemplary aspect of the present invention is applied.

An Orthogonal Frequency Division Multiplexing (OFDM) or Orthogonal Frequency Division Multiple Access (OFDMA) system is one of multi-subcarrier signal transmission systems using multiple subcarriers in a given frequency band. The OFDM and/or OFDMA systems are effectively implemented through Inverse Fast Fourier Transform (IFFT), Fast Fourier Transform (FFT), and so on because subcarriers f₀, f₁, f₂, . . . , f_{N-1} of an equal interval f_{d} are used as illustrated in FIG. 4. In OFDM and/or OFDMA communications, each data frame is transmitted after a preamble for synchronization and channel estimation is inserted into the head end of the data frame.

At this time, the preamble uses some subcarriers of an equal interval in place of all subcarriers for synchronization. In this case, it is easy to acquire time and frequency synchronization because a pattern is repeated in a time domain. FIG. 4 illustrates an example of using even subcarriers f₀, f₂, f₄, . . . for a preamble.

FIG. 5 illustrates a preamble pilot pattern to which an antenna selection diversity method in accordance with another exemplary aspect of the present invention is applied.

OFDM and/or OFDMA systems are effectively implemented through IFFT, FFT, and so on because subcarriers f₀, f₁, f₂, . . . , f_{N-1}, of an equal interval fd are used as illustrated in FIG. 5. FIG. 5 illustrates a preamble pilot pattern based on Institute of Electrical and Electronics Engineers (IEEE) 802.16e. A base station transmits a preamble with a distance of 3 (3 f_{d}) between subcarriers, and a terminal measures channel information between the base station and the terminal using first to third antennas (ANT1, ANT2, and ANT3).

In accordance with a first exemplary embodiment of the present invention as described below, preamble data transmitted through a preamble pilot pattern of FIG. 4 or 5 is received. Herein, the first exemplary embodiment has a structure that exploits multiple analog front ends in a receiver, and a second exemplary embodiment has a structure that exploits a single analog front end in a receiver and measures reception power of each antenna after an FFT processor of the receiver. Finally, a third exemplary embodiment has a structure that exploits a single analog front end in a receiver and measures reception power of each antenna without performing FFT after an ADC.

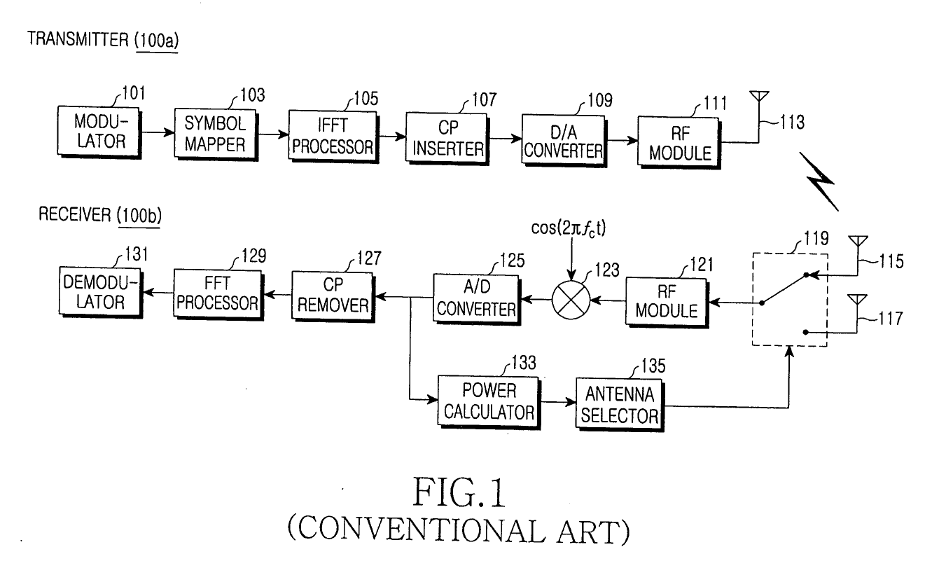

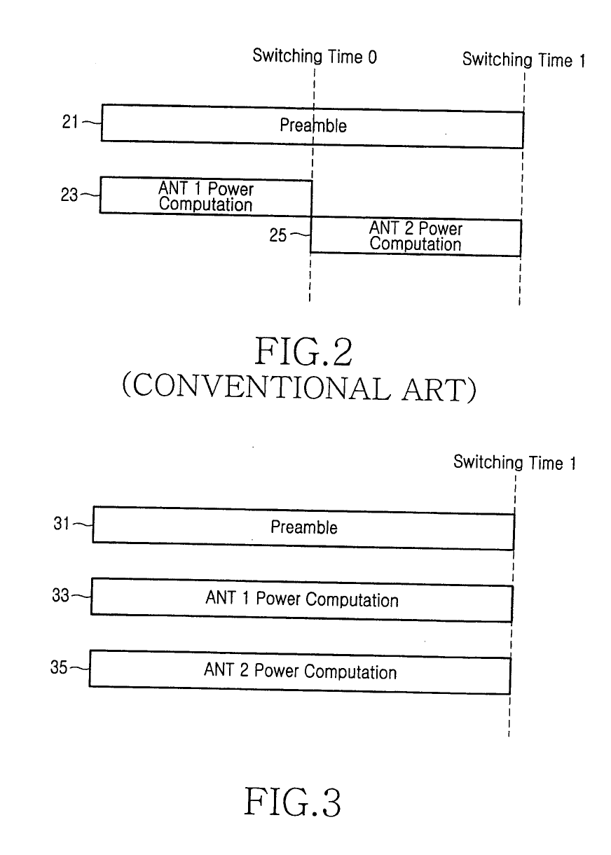

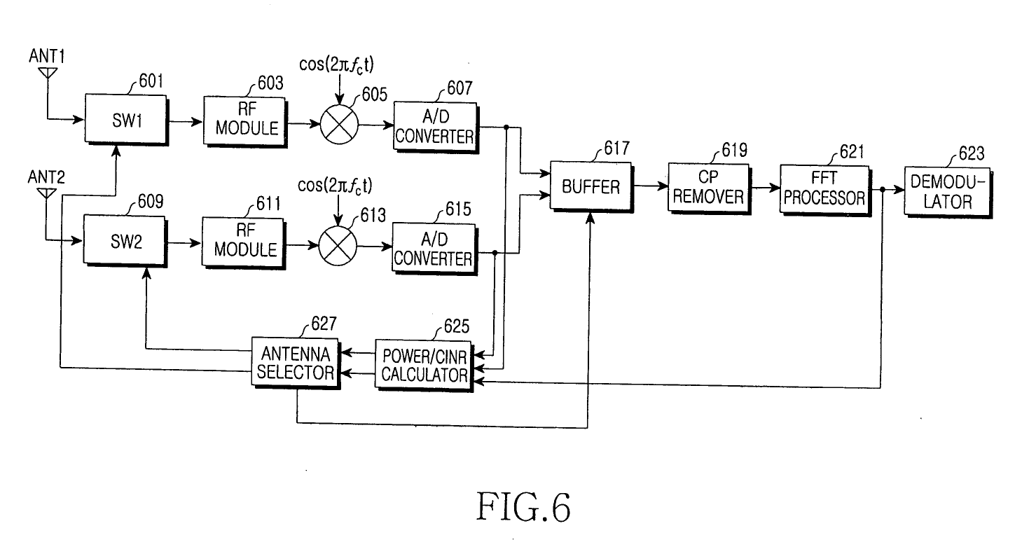

The exemplary embodiments will be described with reference to the proposed structures of FIGS. 6, 8, and 10. An antenna selection diversity apparatus according to an exemplary embodiment of the present invention may exploit a receiver in both a base station and a terminal, and will be described on the basis of the terminal for convenience. A transmitter associated with a receiver of the exemplary embodiment is the transmitter 100a of FIG. 1. The preamble pilot pattern is a pattern, described with reference to FIG. 4 or 5, based on a distance between subcarriers in which a pilot signal is transmitted. For convenience, it is assumed that the number of antennas is two.

FIG. 6 is a block diagram illustrating a structure of a receiver with an antenna selection diversity apparatus in accordance with a first exemplary embodiment of the present invention.

In FIG. 6, an ADC 607 operates as a first analog front end for a first antenna (ANT1) and an ADC 615 operates as a second analog front end for a second antenna (ANT2). Herein, the number of analog front ends increases in proportion to the number of antennas. In FIG. 6, the first and second analog front ends receive preamble data transferred through associated antennas regardless of antenna selection, convert the received preamble data to digital signals, and output the digital signals to a buffer 617. Therefore, switching times for the antennas (ANT1 and ANT2) are set through an antenna selector 627 within a preamble interval as illustrated in FIG. 3. A power/Carrier-to-Interference plus Noise Ratio (CINR) calculator 625 measures power values of signals received through the antennas (ANT1 and ANT2) and the first and second analog front ends or estimates CINRs of the antenna-by-antenna received signals from an output signal of an FFT processor 621. Hereinafter, antenna-by-antenna reception power and CINR information are referred to as antenna selection information.

The reception power values of the antennas (ANT1 and ANT2) measured by the power/CINR calculator 625 are transferred to the antenna selector 627. Preferably, the antenna selector 627 controls switches (SW1 and SW2) 601 and 609 such that an antenna with a relatively large reception power value or CINR is selected as a receive antenna among the antennas (ANT1 and ANT2), and controls an operation for outputting preamble data of an associated antenna to a demodulator 623. The antenna-by-antenna reception power or CINR information can be selectively used as the antenna selection information.

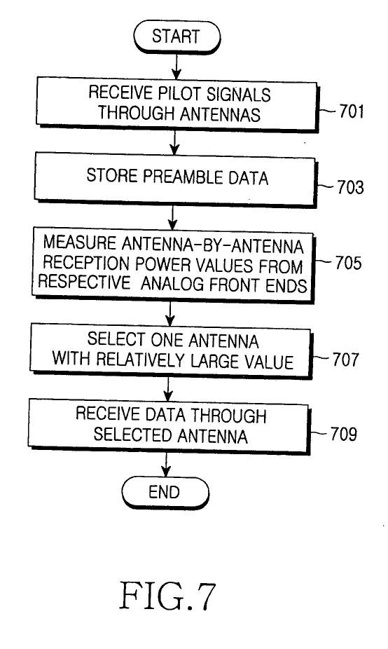

FIG. 7 is a flowchart illustrating an antenna selection diversity process in accordance with an exemplary embodiment of the present invention. The process of FIG. 7 will be described with reference to the structure of FIG. 6.

First, the receiver of FIG. 6 sets switching times for the antennas (ANT1 and ANT2) in a preamble interval as illustrated in FIG. 3. In this case, the switches (SW1 and SW2) 601 and 609 perform switching operations such that the antennas (ANT1 and ANT2) are connected to the associated analog front ends. In step 701, pilot signals (or symbols) including preamble data are received through the antennas (ANT1 and ANT2). The received pilot signals undergo an RF process through the RF modules 603 and 611. An output signal of the RF module 603 or 611 is multiplied by a sinusoidal signal cos(2πf_{c}t) through the multiplier 605 or 613, such that it is demodulated. Herein, f_{c} refers to the center frequency of a subcarrier. In step 703, demodulated pilot signals are converted to digital signals through the ADCs 607 and 615. The buffer 617 stores the digital signals as preamble data mapped to the associated antennas.

In step 705, the power/CINR calculator 625 measures power values of signals output from the respective analog front ends, in other words, reception power values of the antennas (ANT1 and ANT2), or estimates CINRs of received signals of the antennas (ANT1 and ANT2) from an output signal of the FFT processor 621.

In step 707, one antenna with a relatively large reception power value or CINR is selected. The antenna selector 627 controls the buffer 617 such that preamble data of the selected antenna is transferred to the demodulator 623, and selectively turns on the switch 601 or 609 connected to an associated antenna. In step 709, the receiver receives data through only the selected antenna. That is, the received signal converted to the digital signal in the ADC 607 or 615 of an associated antenna path is output to a Cyclic Prefix (CP) remover 619. The CP remover 619 removes a CP inserted into a guard interval. A received signal from which the CP has been removed is transferred to the demodulator 623 through the FFT processor 621. The demodulator 623 performs a predefined demodulation operation on the preamble data transferred in step 709.

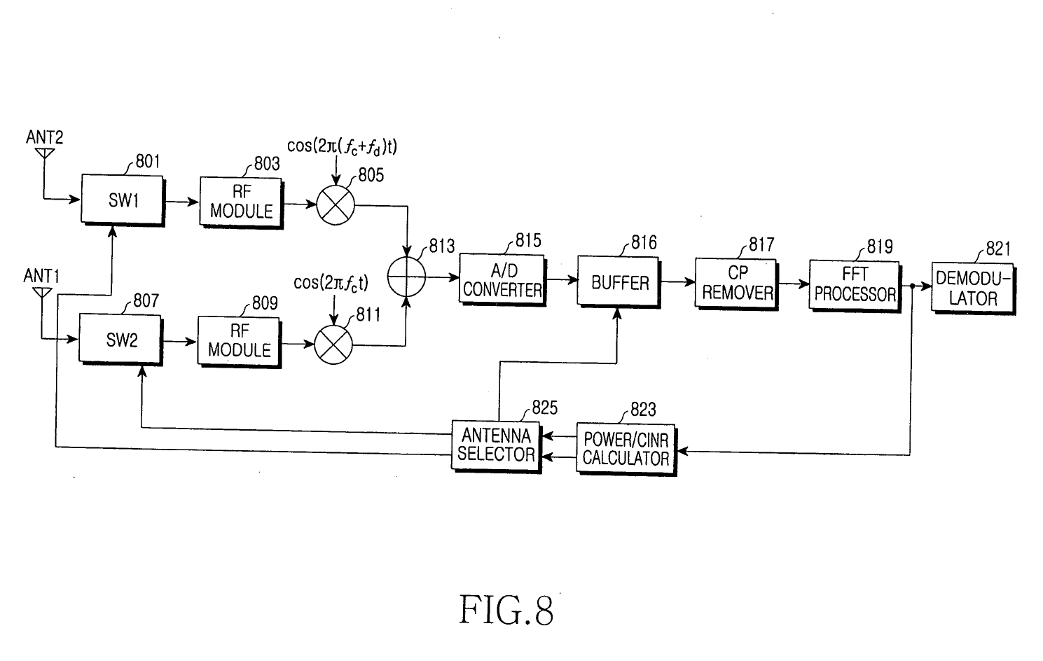

FIG. 8 is a block diagram illustrating a structure of an antenna selection diversity apparatus in accordance with a second exemplary embodiment of the present invention.

To efficiently implement multi-antenna technology, this exemplary embodiment does not exploit multiple analog front ends that increase in proportion to the number of antennas like the previous embodiment. Through a single analog front end, this embodiment implements a multi-antenna system for performing a different demodulation process in an RF domain by considering a distance between subcarriers through which a pilot signal is transmitted. In FIG. 8, an ADC 815 configures the single analog front end for first and second antennas 801 and 807. Using the fact that a subcarrier unused in a preamble is present, this exemplary embodiment obtains information associated with multiple antennas through the single analog front end by performing the demodulation process in the RF domain according to the distance between subcarriers. The information associated with the antennas, in other words, antenna selection information, includes magnitude of a received signal of each antenna, in other words, at least one of channel power information and CINR information.

Assuming that preamble data is transmitted from a transmitter (not illustrated) through even subcarriers, an available subcarrier is defined as shown in Equation (1).

$${f}_{n} = {f}_{c} + ( n - \frac{N}{2} ) {f}_{d} \qquad Equation ( 1 )$$

In Equation (1), n denotes a subcarrier index, n=0, 1, . . . , N−1, N denotes the total number of subcarriers, f_{c} denotes the center frequency, and f_{d} denotes a distance between subcarriers. Therefore, pilot information is transferred through even subcarriers f₀, f₂, f₄, . . . , and a null signal of “0” is transferred through odd subcarriers f₁, f₃, f₅, . . . .

In the structure of FIG. 8, a pilot signal passing through a second antenna (ANT2) passes through a switch (SW1) 801 and an RF module 803 of an associated path, and then is multiplied by a sinusoidal signal cos(2π(f_{c}+f_{d})t) in a multiplier 805, such that it is demodulated. In this case, because the pilot signal passing through the second antenna (ANT2) is demodulated to f_{c}+f_{d}, it is arranged in positions of (−N/2+1)f_{d}, (−N/2+3)f_{d}, . . . , in other words, f₁, f₃, f₅, . . . , in a baseband as illustrated in FIG. 4, after an Analog-to-Digital (A/D) conversion process. Because the pilot signal passing through a first antenna (ANT1) is demodulated to f_{c}, it is arranged in positions of (−N/2)f_{d}, (−N/2+2)f_{d}, (−N/2+4)f_{d}, . . . , in other words, f₀, f₂, f₄, . . . , in a baseband as illustrated in FIG. 4, after an A/D conversion process.

Next, there will be described signals input to the ADC 815 after pilot signals received through the first and second antennas (ANT1 and ANT2) are demodulated. As illustrated in FIG. 4, the signals passing through the first and second antennas (ANT1 and ANT2) are separately arranged in the odd and even subcarrier positions. When the signals arranged as described above pass through the FFT processor 819 such that they can be distinguished on a frequency-by-frequency basis, the receiver can completely separate received signals of the first and second antennas. Through this process, reception power values for the first and second antennas (ANT1 and ANT2) can be measured.

For antenna selection diversity in the structure of FIG. 8, a power/CINR calculator 823 measures antenna-by-antenna reception power values, or estimates antenna-by-antenna CINRs, to be used as the antenna selection information from an output signal of the FFT processor 819. An antenna selector 825 selects a relatively large reception power value or CINR, controls an operation for turning on the switch SW1 or SW2 connected to an associated antenna, and controls the buffer 816 such that preamble data of the selected antenna is transferred to the demodulator 821. If the second antenna (ANT2) is selected, a demodulation operation is performed using the center frequency f_{c} in place of f_{c}+f_{d} for normal data reception thereafter. The antenna-by-antenna reception power or CINR information can be selectively used.

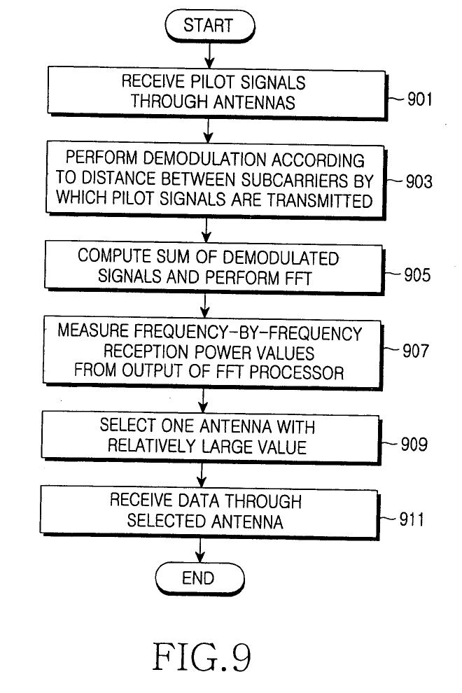

FIG. 9 is a flowchart illustrating an antenna selection diversity process in accordance with the second exemplary embodiment of the present invention. The process of FIG. 9 will be described with reference to the structure of FIG. 8.

First, a receiver of FIG. 8 sets switching times for the antennas (ANT1 and ANT2) in a preamble interval as illustrated in FIG. 3. In this case, the switches (SW1 and SW2) 801 and 807 perform switching operations such that the antennas (ANT1 and ANT2) are connected to the single analog front end. In step 901, pilot signals (or symbols) including preamble data are received through the antennas (ANT1 and ANT2). After the received pilot signals undergo an RF process through the RF modules 803 and 809, output signals of the RF modules 803 and 809 are multiplied by sinusoidal signals cos(2π(f_{c}+f_{d})t) and cos(2πf_{c}t) in the multipliers 805 and 811, respectively, such that they are demodulated in step 903. Herein, f_{c} refers to the center frequency of a subcarrier and f_{d} denotes a distance between subcarriers. As described above, the antenna-by-antenna received signals are demodulated to different frequencies according to a distance between subcarriers through which pilot signals are transmitted.

In step 905, an adder 813 computes a sum of the pilot signals demodulated according to the sinusoidal signals cos(2π(f_{c}+f_{d})t) and cos(2πf_{c}t), and the ADC 815 converts the sum of the pilot signals to a digital signal and then outputs the digital signal to a CP remover 817. The CP remover 817 removes a CP inserted into a guard interval. The pilot signal from which the CP has been removed is converted to a frequency domain signal through the FFT processor 819. The frequency domain signal is separated into signals of the first antenna (ANT1) and the second antenna (ANT2). The signals are converted to a serial signal through a parallel-to-serial converter (not illustrated) and the serial signal is transferred to a demodulator 821. The demodulator 821 demodulates the serial signal.

In step 907, the power/CINR calculator 823 measures power values of antenna-by-antenna frequency signals output from the FFT processor 819, in other words, antenna-by-antenna reception power values, or estimates antenna-by-antenna CINRs from the output signals of the FFT processor 819. In step 909, one antenna with a relatively large reception power value or CINR is selected. At this time, the antenna selector 825 selectively turns on the switch 801 or 807 connected to the selected antenna. In step 911, the receiver receives data through only the selected antenna. The buffer 816 of FIG. 8 stores preamble data received from the first and second antennas (ANT1 and ANT2). After the antenna selection has been completed, the preamble data stored in the buffer 816 can be used for channel estimation and so on.

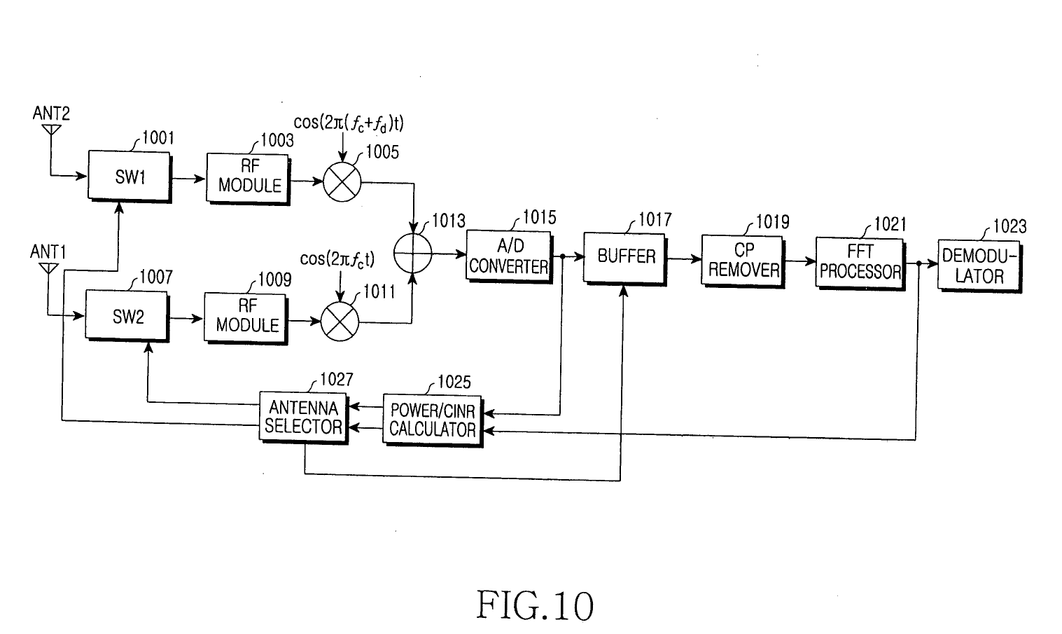

FIG. 10 is a block diagram illustrating a structure of an antenna selection diversity apparatus in accordance with a third exemplary embodiment of the present invention.

Through a single analog front end, this exemplary embodiment implements a multi-antenna system for performing a different demodulation process in an RF domain by considering a distance between subcarriers through which a pilot signal is transmitted. This exemplary embodiment proposes a structure for measuring antenna-by-antenna reception power values from an output of an ADC without use of an output of an FFT processor for measuring antenna-by-antenna reception power values as in the previous exemplary embodiment. There are advantageous in that this exemplary embodiment can reduce power consumption due to an FFT process and can reduce a time required to select an antenna.

In an OFDM system using N subcarriers, it is assumed that preamble data is transmitted using even subcarriers as illustrated in FIG. 4. When a signal obtained by removing a CP from a received OFDM symbol is y[n] where n=0, 1, . . . , N−1, an output of the FFT processor can be obtained as y(k) where k=0, 1, . . . , N−1.

Herein, power of the even subcarriers can be expressed as shown in Equation (2).

$${P}_{e} = {\sum }_{k = 0}^{N / 2 - 1} {\vert y ( k ) \vert}^{2} = {\sum }_{k = 0}^{N - 1} {\vert G ( k ) y ( k ) \vert}^{2} = {\sum }_{k = 0}^{N - 1} {\vert z ( k ) \vert}^{2} \qquad Equation ( 2 )$$

In Equation (2), a subcarrier index is set to k=0, 2, 4, . . . when G(k)=1. When G(k)=0, a subcarrier index is set to k=1, 3, 5, . . . .

When a product of G(k) and y(k) corresponding to the output of the FFT processor is defined as z(k)=G(k) y(k), Equation (3) can be produced using Parseval's theorem indicating that power of a periodic signal is equal to a sum of power values of Fourier components.

$${P}_{c} = {\sum }_{k = 0}^{N - 1} {\vert z ( k ) \vert}^{2} = {\sum }_{k = 0}^{N - 1} {\vert z [ n ] \vert}^{2} \qquad Equation ( 3 )$$

In Equation (3), z[n] is an IFFT signal of z(k). z(k) is expressed by a product of G(k) and y(k) as in z(k)=G(k) y(k) in a discrete frequency domain, and is expressed by circular convolution

$$z [ n ] = {\sum }_{l = 0}^{N - 1} G [ l ] y [ ( n - l ) N ]$$

in a time domain. Herein, G[n] is an IFFT signal of G(k). Accordingly, it can be seen that an estimate of P_{c} is equal to output power of a circular convolution filter of y[n] and G[n]. An IFFT signal of G(k) is obtained by G[n]=δ[n]+δ[n−512].

Thus, a filter output for power measurement of even subcarriers can be obtained as shown in Equation (4).
z[n]=0.5(y[n]+y[(n−512)N]) Equation (4)

Similarly, power measurement of odd subcarriers can be computed with a filter output of Equation (5) using G[n]=δ[n]−δ[n−512].
z[n]=0.5(y[n]−y[(n−512)N]) Equation (5)

Using Equations (4) and (5), reception power values for the first and second antennas (ANT1 and ANT2) can be measured. In the structure of FIG. 10, a power/CINR calculator 1025 computes filter outputs using Equations (4) and (5) for an output signal of an ADC 1015, and measures antenna-by-antenna reception power values or estimates antenna-by-antenna CINRs from an output signal of an FFT processor 1021. An antenna selector 1027 selects a relatively large reception power value or CINR, and controls an operation for turning on the switch SW1 or SW2 connected to an associated antenna. If the second antenna (ANT2) is selected in this embodiment, a demodulation operation is performed using the center frequency f_{c} in place of f_{c}+f_{d} for normal data reception. The antenna-by-antenna reception power or CINR information can be selectively used.

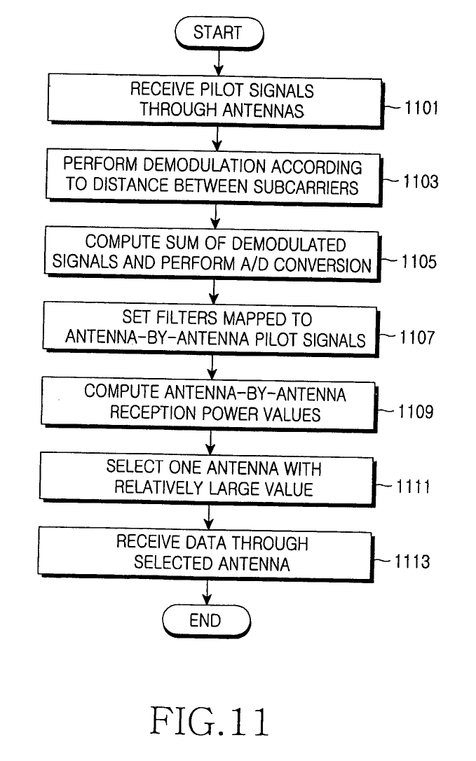

FIG. 11 is a flowchart illustrating an antenna selection diversity process in accordance with the third exemplary embodiment of the present invention. The process of FIG. 11 will be described with reference to the structure of FIG. 10.

First, a receiver of FIG. 11 sets switching times for the antennas (ANT1 and ANT2) in a preamble interval as illustrated in FIG. 3. In this case, switches (SW1 and SW2) 1001 and 1007 perform switching operations such that the antennas (ANT1 and ANT2) are connected to the single analog front end. In step 1101, pilot signals (or symbols) including preamble data are received through the antennas (ANT1 and ANT2). After the received pilot signals undergo an RF process through RF modules 1003 and 1009, output signals of RF modules 1003 and 1009 are multiplied by sinusoidal signals cos(2π(f_{c}+f_{d})t) and cos(2πf_{c}t) in multipliers 1005 and 1011, such that they are demodulated in step 1103. The antenna-by-antenna received signals are demodulated to different frequencies according to a distance between subcarriers through which pilot signals are transmitted.

In step 1105, an adder 1013 computes a sum of the pilot signals demodulated according to the sinusoidal signals cos(2π(f_{c}+f_{d})t) and cos(2πf_{c}t), and an ADC 1015 converts the sum of the pilot signals to a digital signal. In step 1107, the power/CINR calculator 1025 sets a filter based on Equation (4) or (5) for the output signal of the ADC 1015. In step 1109, the power/CINR calculator 1025 computes an output based on each set filter, and measures antenna-by-antenna power values or estimates antenna-by-antenna CINRs from an output signal of the FFT processor 1021. In step 1111, the antenna selector 1027 selects one antenna with a relatively large reception power value or CINR, controls a buffer 1017 such that preamble data of the selected antenna is transferred to a demodulator 1023, and selectively turns on the switch 1001 or 1007 connected to an associated antenna. In step 1113, the receiver receives data through only the selected antenna. After the received data is transferred to the demodulator 1023 through the CP remover 1019 and the FFT processor 1021, it is demodulated in the demodulator 1023.

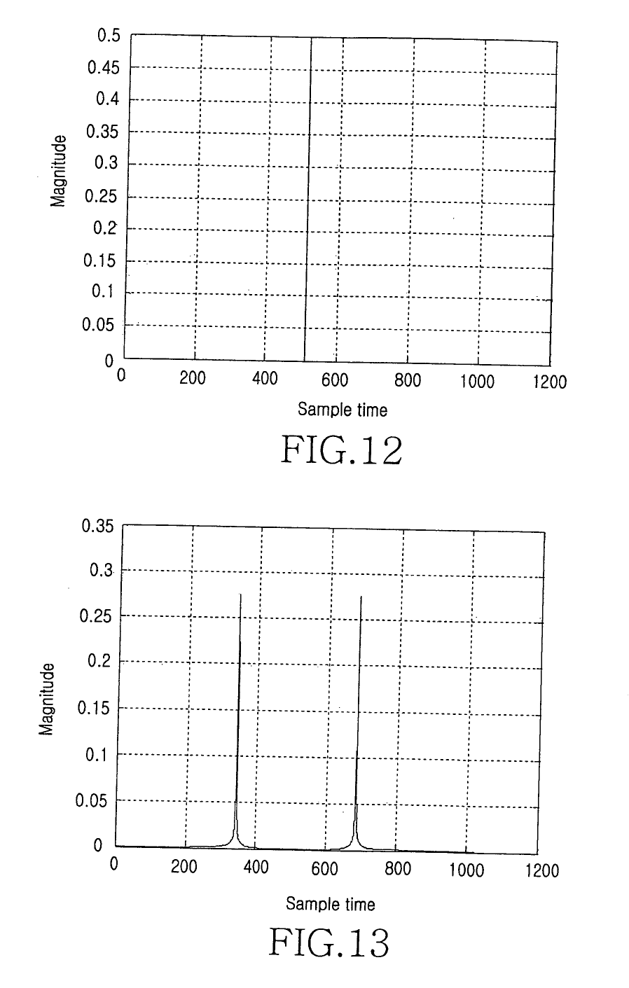

FIG. 12 illustrates a time response of G[n] corresponding to an IFFT signal of G(k), in other words, magnitude of a filter coefficient, in relation to the third exemplary embodiment. Referring to FIG. 12, it can be seen that a filter for measuring antenna-by-antenna reception power values can be implemented with a simple linear filter. In accordance with the third exemplary embodiment, an antenna selection diversity apparatus can be implemented without requiring FFT for an output of an ADC.

FIG. 13 illustrates a time response of G[n], in other words, a filter coefficient, for power estimation at the time of using preamble subcarriers based on the multiples of 3. In this case, filter implementation is relatively complex as compared with filter implementation for a preamble using even and odd subcarriers. Referring to FIG. 13, a simplified power/CINR calculator can be implemented when the approximation is made while considering that filter energy is focused at sample times of about 342 and 684.

For convenience, it is assumed that the number of antennas is two in the exemplary embodiments. When one of at least three antennas is selected, a switch, an RF module, a multiplier, or an analog front end mapped to an associated antenna is further included in the exemplary structures of FIGS. 6, 8, and 10. Because an operation in the case where one of at least three antennas is selected is similar to the above-described operation, its detailed description is omitted herein.

As described above, the present invention can use preamble data transmitted from a transmitter when multiple antennas are selectively used in a receiver of a broadband wireless communication system and can provide an improved antenna selection diversity apparatus and method in the receiver using single or multiple analog front ends.

While the invention has been shown and described with reference to certain embodiments thereof, it will be understood by those skilled in the art that various changes in form and details may be made therein without departing from the spirit and scope of the invention as defined by the appended claims.

What is claimed is:

1. A reception apparatus for performing antenna selection diversity in a broadband wireless communication system, comprising:
a plurality of antennas for receiving pilot signals transmitted in a regular period;
a plurality of demodulators for demodulating antenna-by-antenna received signals to different frequencies according to a distance between subcarriers through which the pilot signals are transmitted;
a Fast Fourier Transform (FFT) processor for performing an FFT process for the antenna-by-antenna received signals;
a power calculator for measuring antenna-by-antenna reception power values from an output signal of the FFT processor; and
an antenna selector for selecting an antenna with a largest reception power value as a receive antenna among the plurality of antennas.

2. The reception apparatus of claim 1, wherein an output path of the plurality of demodulators is connected to a single analog front end.

3. The reception apparatus of claim 1, wherein the power calculator measures the reception power values of the plurality of antennas in an identical preamble interval of the pilot signals.

4. The reception apparatus of claim 1, further comprising:
a Carrier-to-Interference plus Noise Ratio (CINR) calculator for estimating antenna-by-antenna CINRs from an output signal of the FFT processor,
wherein the antenna selector selects the receive antenna using at least one of the antenna-by-antenna reception power values and the antenna-by-antenna CINRs.

5. A reception apparatus for performing antenna selection diversity in a broadband wireless communication system, comprising:
a plurality of antennas for receiving pilot signals transmitted in a regular period;
a plurality of demodulators for demodulating antenna-by-antenna received signals to different frequencies according to a distance between subcarriers through which the pilot signals are transmitted;
a single analog front end for converting the antenna-by-antenna received signals to digital signals;
a power calculator for measuring antenna-by-antenna reception power values from an output signal of the single analog front end; and
an antenna selector for selecting an antenna with a largest reception power value as a receive antenna among the plurality of antennas.

6. The reception apparatus of claim 5, wherein the power calculator measures the reception power values of the plurality of antennas in an identical preamble interval of the pilot signals.

7. The reception apparatus of claim 5, wherein the power calculator measures the antenna-by-antenna reception power values using a linear filter.

8. The reception apparatus of claim 5, wherein the pilot signals are even or odd subcarriers.

9. The reception apparatus of claim 5, further comprising:
a Fast Fourier Transform (FFT) processor for performing an FFT process for the received signals; and
a Carrier-to-Interference plus Noise Ratio (CINR) calculator for estimating antenna-by-antenna CINRs from an output signal of the FFT processor,
wherein the antenna selector selects the receive antenna using at least one of the antenna-by-antenna reception power values and the antenna-by-antenna CINRs.

10. An antenna selection diversity method of a receiver in a broadband wireless communication system, comprising the steps of:
receiving pilot signals transmitted in a regular period through a plurality of antennas;
demodulating antenna-by-antenna received signals to different frequencies according to a distance between subcarriers through which the pilot signals are transmitted;
performing a Fast Fourier Transform (FFT) process for the antenna-by-antenna demodulated received signals;
measuring antenna-by-antenna reception power values from the received signals converted in the FFT process; and
selecting an antenna with a largest reception power value as a receive antenna among the plurality of antennas.

11. The antenna selection diversity method of claim 10, wherein the antenna-by-antenna demodulated received signals are converted to digital signals through a single analog front end.

12. The antenna selection diversity method of claim 10, wherein the measuring step comprises the step of:
measuring the antenna-by-antenna reception power values in an identical preamble-interval of the pilot signals.

13. The antenna selection diversity method of claim 10, further comprising the steps of:
estimating antenna-by-antenna Carrier-to-Interference plus Noise Ratios (CINRs) from the received signals of a frequency domain based on FFT; and
selecting the receive antenna using at least one of the antenna-by-antenna reception power values and the antenna-by-antenna CINRs.

14. An antenna selection diversity method of a receiver in a broadband wireless communication system, comprising the steps of:
receiving pilot signals transmitted in a regular period through a plurality of antennas;
demodulating antenna-by-antenna received signals to different frequencies according to a distance between subcarriers through which the pilot signals are transmitted;
converting the pilots signals, received by the plurality of antennas, to digital signals through a single analog front end;
measuring antenna-by-antenna reception power values from an output signal of the single analog front end; and
selecting an antenna with a largest reception power value as a receive antenna among the plurality of antennas.

15. The antenna selection diversity method of claim 14, wherein the measuring step comprises the step of:
measuring the antenna-by-antenna reception power values in an identical preamble interval of the pilot signals.

16. The antenna selection diversity method of claim 14, wherein the measuring step comprises the step of:
measuring the antenna-by-antenna reception power values using a linear filter.

17. The antenna selection diversity method of claim 14, wherein the pilot signals are even or odd subcarriers.

18. The antenna selection diversity method of claim 14, further comprising the steps of:
performing an Fast Fourier Transform (FFT) process for the received signals converted to the digital signals;
estimating antenna-by-antenna Carrier-to-Interference plus Noise Ratios (CINRs) from the received signals of a frequency domain based on FFT; and
selecting the receive antenna using at least one of the antenna-by-antenna reception power values and the antenna-by-antenna CINRs.
